(19) United States
(12) Patent Application Publication
(10) Pub. No.: US 2012/0240768 A1
(43) Pub. Date: Sep. 27, 2012

(54) SYSTEM FOR REMOVING MOISTURE FROM AN AIRSTREAM

(75) Inventors: Richard Michael Ashley Mann, Basingstoke (GB); Abhijeet Madhukar Kulkarni, Basingstoke (GB)

(73) Assignee: General Electric Company

(21) Appl. No.: 13/053,669

(22) Filed: Mar. 22, 2011

(51) Int. Cl. B03C 1/00

(52) U.S. Cl. 96/2; 96/1

(57) ABSTRACT

Embodiments of the present invention operate as a mist eliminator. Here, at least one magnet is attached to a structure having metallic surfaces that engage an airstream entering an inlet system of a turbomachine. This structure is connected to the inlet system and operates as the mist eliminator. Depending on the velocity of the entering airstream, and the orientation of the magnets, the mist eliminator may repel the mist particles, which will separate from the airstream. Alternatively, the mist particles may be attracted to the mist eliminator. Here, the mist particles may separate from the airstream and then condense.

### BACKGROUND OF THE INVENTION

The present invention relates generally to an inlet system that channels an airstream to an air-ingesting machine; and more particularly to a system for removing mist particles from the ingested airstream.

Some turbomachines, such as, but not limiting of, gas turbines, have an inlet system that channels the incoming airstream towards the associated compressor. The inlet system usually has a filter section, which screens the airstream for foreign objects and other undesired materials. The filter section restricts the airstream entering the inlet system. This causes a differential pressure (DP) across the filter section.

Moisture within the airstream has the form of small mist particles. The typical inlet system may not remove the small mist particles from the airstream. Therefore, as the airstream is ingested, the mist particles may attach to some filter section components. This behavior increases the DP across the filter section, causing a decrease in efficiency of the gas turbine.

For the foregoing reasons, there is a need for a system that removes mist particles from the airstream. The system should provide a simple and cost effective way to prevent an increase in the DP across the inlet system.

### BRIEF DESCRIPTION OF THE INVENTION

In accordance with an embodiment of the present invention, a system for removing moisture from an airstream, the system comprising: a magnetic mist eliminator comprising: a separator comprising a first surface, an opposite second surface, and a plurality of holes passing through the first surface and the second surface; wherein the first surface faces an airstream entering an inlet system; and a magnet that magnetizes the separator, wherein an area of the magnet is connected to the separator in a location adjacent the plurality of the holes; and another area of the magnet is connected to the inlet system; wherein the magnetic mist eliminator removes mist particles from the airstream, which is flowing through the inlet system.

In accordance with an alternate embodiment of the present invention, a system for removing moisture from an airstream, the system comprising: a turbomachine comprising a compressor and a turbine section; an inlet system connected to the turbomachine upstream of the compressor; wherein the inlet system comprises: a weather hood; an inlet filter house; a transition piece; an inlet duct; and an inlet plenum; a magnetic mist eliminator comprising: a separator comprising a first surface, an opposite second surface, and a plurality of holes passing through the first surface and the second surface; wherein the first surface faces an airstream flowing into an inlet system; and a magnet that magnetizes the separator, wherein a first side of the magnet is connected to the separator in a location adjacent the plurality of the holes; and a second side of the magnet is connected to the inlet system; wherein the separator separates mist particles from the airstream, as the airstream flows through the inlet system.

### BRIEF DESCRIPTION OF THE DRAWINGS

These and other features, aspects, and advantages of the present invention are explained when the following detailed description is read with reference to the accompanying figures (FIGS) in which like characters represent like elements throughout the FIGS.

FIG. 1 is a schematic illustrating an environment where an embodiment of the present invention may operate.

FIG. 2 is a schematic illustrating an isometric view of an embodiment of a magnetic mist eliminator system of FIG. 1, in accordance with embodiments of the present invention.

FIGS. 3A and 3B, collectively FIG. 3, are schematics illustrating isometric views of a second embodiment of a magnetic mist eliminator system of FIG. 1, in accordance with embodiments of the present invention.

FIGS. 4A and 4B, collectively FIG. 4, are schematics illustrating isometric views of a third embodiment of a magnetic mist eliminator system of FIG. 1, in accordance with embodiments of the present invention.

### DETAILED DESCRIPTION OF THE INVENTION

Embodiments of the present invention use the magnetic property of water to remove water mist particles from an airstream entering the inlet system. A water particle has a magnetic dipole moment of around 1.85 D. Based on this property, a magnetized structure can be controlled in a manner that may attract or repel the mist particles. This may cause the mist particles to separate from the airstream.

As discussed below, embodiments of this invention operate as a mist eliminator. Here, at least one magnet is attached to a structure with metallic surfaces that engage the airstream. This structure is connected to the inlet system, and operates as the mist eliminator. Depending on the velocity of the airstream and the orientation of the magnets, the mist eliminator may repel the mist particles, which may separate from the airstream. Alternatively, the mist particles may be attracted to the mist eliminator. Here, the mist particles may separate from the airstream and then condense.

Essentially, the present invention magnetizes a metallic structure, connected to an inlet system, with the goal of separating mist particles from the airstream. This may reduce the DP across the inlet system of the associated turbomachine.

The following detailed description of preferred embodiments refers to the accompanying drawings, which illustrate specific embodiments of the invention. Other embodiments having different structures and operations do not depart from the scope of the present invention.

Certain terminology may be used herein for the convenience of the reader only and is not to be taken as a limitation on the scope of the invention. For example, words such as “upper”, “lower”, “left”, “right”, “front”, “rear”, “top”, “bottom”, “horizontal”, “vertical”, “upstream”, “downstream”, “fore”, “aft”, and the like; merely describe the configuration shown in the FIGS. Indeed, the element or elements of an embodiment of the present invention may be oriented in any direction and the terminology, therefore, should be understood as encompassing such variations unless specified otherwise.

Detailed example embodiments are disclosed herein. However, specific structural and functional details disclosed herein are merely representative for purposes of describing example embodiments. Example embodiments may, however, be embodied in many alternate forms, and should not be construed as limited to only the embodiments set forth herein.

Accordingly, while example embodiments are capable of various modifications and alternative forms, embodiments thereof are illustrated by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any, and all, combinations of one or more of the associated listed items.

The terminology used herein is for describing particular embodiments only and is not intended to be limiting of example embodiments. As used herein, the singular forms “a”, “an” and “the” are intended to include the plural forms as well, unless the context clearly indicates otherwise. The terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

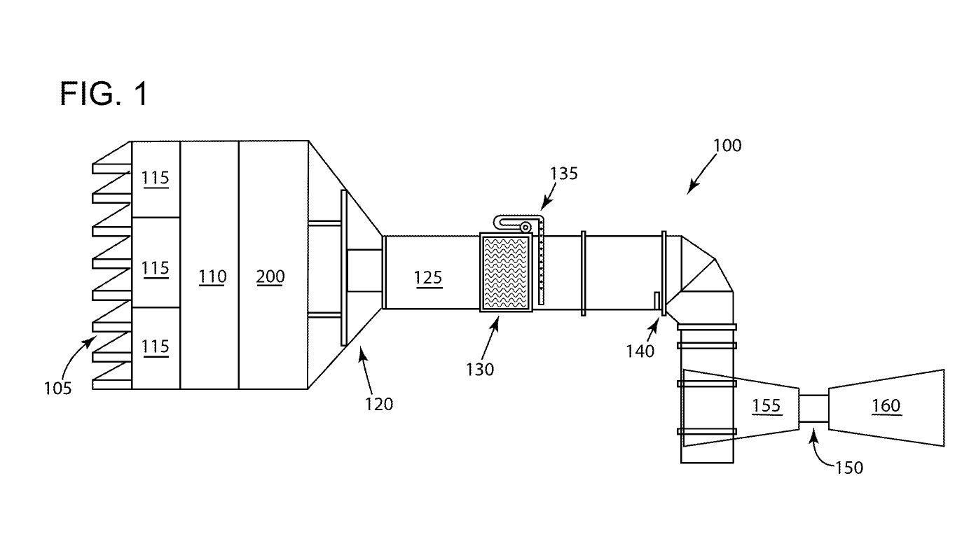

The present invention may be applied to a variety of inlet systems. This may include, but is not limiting to, those integrated with air-ingesting turbomachines. Although the following discussion relates to the inlet system illustrated in FIG. 1, embodiments of the present invention may be applied to an inlet system with a different configuration. For example, but not limiting of, the present invention may apply to an inlet system having different, or additional, components than those illustrated in FIG. 1.

Referring now to the FIGS, where the various numbers represent like elements throughout the several views, FIG. 1 is a schematic illustrating an environment where an embodiment of the present invention may operate. FIG. 1 illustrates an inlet system 100 that may be integrated with a compressor 155 of a turbomachine 150. During operation of the turbomachine 150, the compressor 155 ingests an airstream that may contain mist particles.

The following description provides an overview of a typical configuration of an inlet system 100. The present invention may be used with other configurations of the inlet system 100, which are not illustrated in the FIGS. The inlet system 100 channels the airstream ingested by the compressor 155. The airstream typically derives from the environment in which the turbomachine 150 operates. Initially, the airstream flows around a weather hood 105; which may prevent weather elements, such as rain, snow, etc, from entering the compressor 155. The airstream may then flow through an inlet filter house 110; which generally removes foreign objects (including sand and other airborne particulate matter) and debris from the airstream. Next, the airstream may flow through a transition piece 120 and an inlet duct 125; these components may adjust the velocity and pressure of the airstream. Next, the airstream may flow through a silencer section 130. Next, the airstream may flow through an air condition system 135, which can increase the airstream temperature prior to entering the compressor 155. Examples of the air conditioning system 135 may include, but are not limited to: an inlet bleed heat system, an inlet chilling system, or heating coils. A screen 140, or the like, may be located downstream of the inlet duct 125 and generally serves to prevent debris from entering the compressor 155. The inlet plenum 145 may connect the inlet system 100 with the compressor 155.

Embodiments of the present invention provide a magnetic mist eliminator 115, which functions to remove some of the mist particles within the airstream entering the inlet system 100. The magnetic mist eliminator 115 is installed, or positioned, upstream of the inlet filter house 110, as illustrated in FIG. 1. Operatively, the magnetic mist eliminator 115 may remove mist particles before the airstream engages the inlet filter house 110.

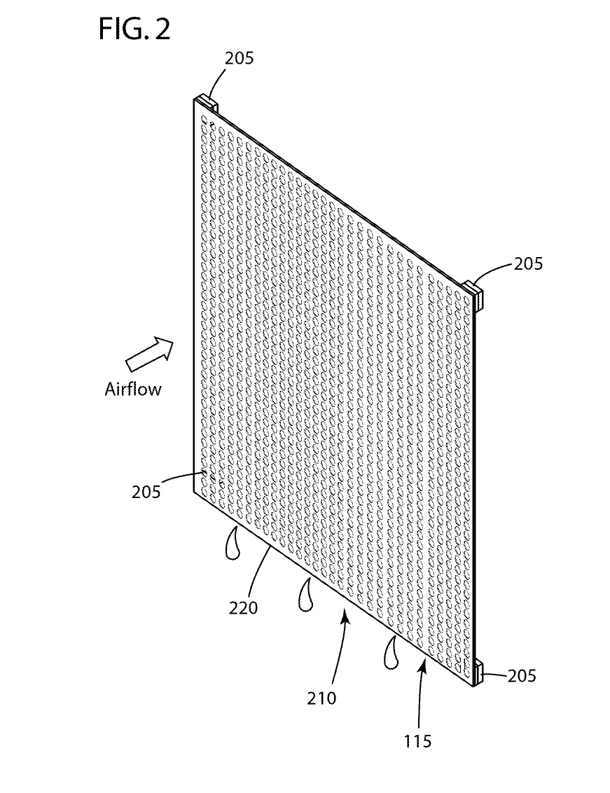

Referring now to FIG. 2, which is a schematic illustrating an isometric view of an embodiment of the magnetic mist eliminator 115 of FIG. 1, in accordance with embodiments of the present invention. An embodiment of the magnetic mist eliminator 115 may comprise a separator 200 and a magnet 205.

In an embodiment of the present invention, the separator 200 may have the form of a mesh screen located upstream of the inlet filter house 110. The separator 200 may have ferrous outer surfaces, which may be magnetized by the magnet 205. In an embodiment of the present invention the separator 200 may be formed out of a ferrous material; a nonferrous material; or a polymeric material having, paramagnetic or diamagnetic properties, which may be magnetized.

An embodiment of the separator 200 may have a first surface, an opposite second surface, and a plurality of holes 210 passing through the first surface and the second surface. The first surface may be orientated in a manner that faces the airstream entering the inlet system 100. Depending on the location where the magnetic mist eliminator 115 is installed, embodiments of the separator 200 may include: a rectangular shape, a square shape, a circular shape, a triangular shape, or any combination thereof. The airstream may be parallel or perpendicular to the surface. Alternatively, the airstream may be in a mixed flow form.

The plurality of holes 210 may allow the ingested airstream to flow through the separator 200. Ideally, the plurality of holes 210 may allow the airstream to flow through the separator 200, while maintaining a small DP across the separator 200. In an embodiment of the present invention, each of the plurality of holes 210 may have nearly the same diameter. In an alternate embodiment of the present invention, the plurality of holes 210 may be of varying diameters.

The magnet 205 serves to magnetize surfaces of the separator 200 that the airstream may engage. Embodiments of the present invention may incorporate one, or more, magnets 205. As illustrated in FIG. 2, an embodiment of the present invention may use four (4) magnets 205. Here, a magnet 205 is positioned near a corner of the separator 200 that may have the shape of a square. A first side of the magnet 205 may be connected to the separator 200 in a location adjacent the plurality of the holes 210. A second side of the magnet 205 may be connected to a component of the inlet system 100, such as, but not limiting of, the weather hood 105. The shape of the magnet 205 may include any form that may allow the magnet 205 to be affixed to both a portion of the magnetic mist eliminator 115 and a component of the inlet system 100.

The present invention may incorporate many types of magnets 205. In an embodiment of the present invention, the magnet 205 may be an electromagnet energized by DC current. In an alternate embodiment of the present invention, the magnet 205 may be an electromagnet energized by AC current. In another embodiment of the present invention, the magnet 205 may be a permanent magnet 205. In another alternate embodiment of the present invention, the magnetic mist eliminator 115 may comprise multiple magnets 205. Here, the multiple magnets 205 may include some combination of all of the aforementioned types, and others not mentioned.

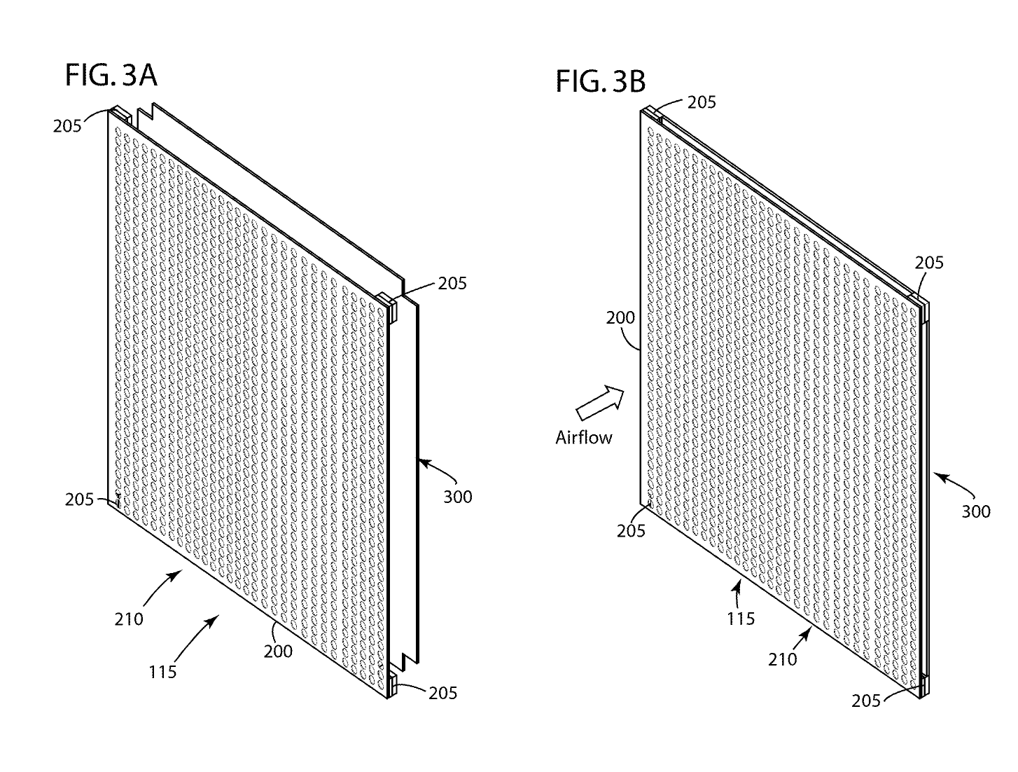

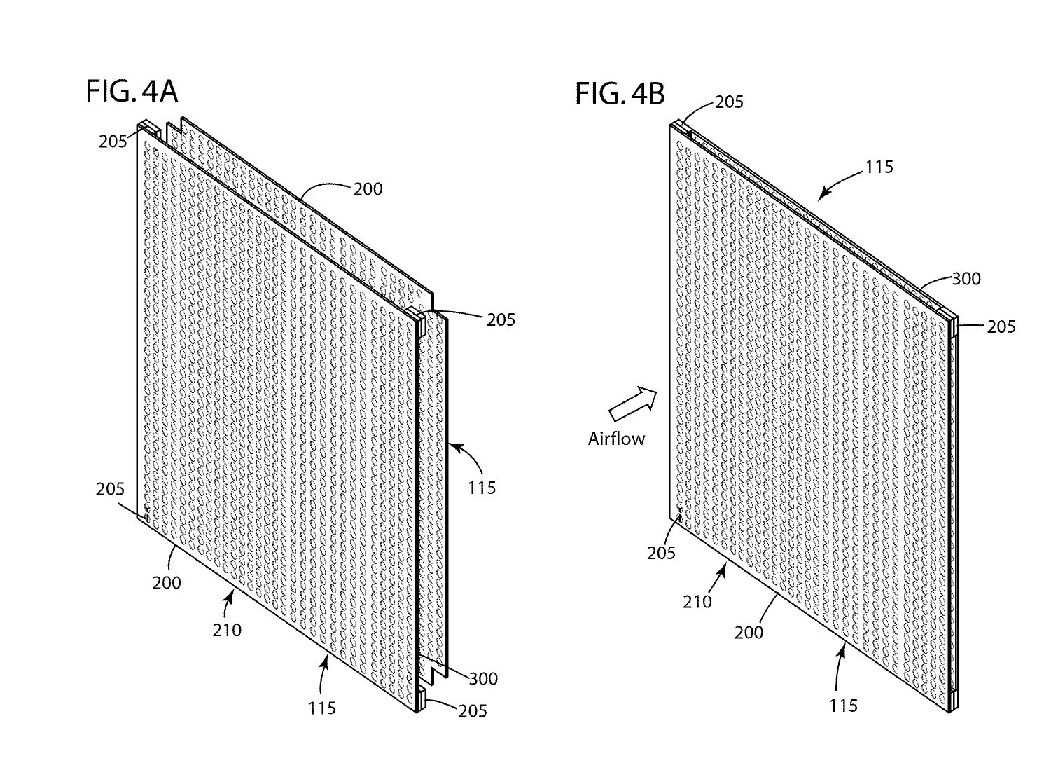

FIGS. 3 and 4 illustrate alternate embodiments of the magnetic mist eliminator 115. The following discussion of FIGS. 3 and 4 is limited to the distinguishing features of alternate embodiments.

FIGS. 3A and 3B, collectively FIG. 3, are schematics illustrating isometric views of a second embodiment of the present invention. FIG. 3A illustrates an exploded view of the second embodiment. FIG. 3B illustrates an assembled view of the second embodiment.

FIG. 3 illustrates the addition of a coalescing media 300 to the magnetic mist eliminator 115. The coalescing media 300 rapidly changes the direction of the airstream. Here, mist particles tend to collide with the substance of the coalescing media 300, coalescence, and then separate from the airstream. The addition of the coalescing media 300 may increase the overall effectiveness of the magnetic mist eliminator 115 at removing mist particles from the airstream. As illustrated in FIG. 3, the coalescing media 300 may be positioned downstream of the separator 200 and integrated with the magnet 205.

FIGS. 4A and 4B, collectively FIG. 4, are schematics illustrating isometric views of a third embodiment of a magnetic mist eliminator 115 of the present invention. FIG. 4A illustrates an exploded view of the third embodiment. FIG. 4B illustrates an assembled view of the third embodiment.

FIG. 4 illustrates the addition of another separator 200 to the magnetic mist eliminator 115. This may increase the overall effectiveness of the magnetic mist eliminator 115. In an embodiment of the present invention, the magnetic mist eliminator 115 may be assembled such that the coalescing media 300 is sandwiched between the two separators 200.

In use, embodiments of the present invention magnetizes the separator 200 such that an induced magnetic force directs the motion of the mist particles. An operator of the magnetic mist eliminator 115 may desire to repel the mist particles. Here, the orientation of the magnet 205, may be arranged in a manner that the positive pole faces upstream. This may repel the positively charged mist particles. Alternatively, an operator of the magnetic mist eliminator 115 may desire to attract the mist particles to a drainage system. Here, the orientation of the magnet 205, may be arranged in a manner that the negative pole faces upstream. This may attracted the positively charged mist particles.

Although specific embodiments have been illustrated and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

As one of ordinary skill in the art will appreciate, the many varying features and configurations described above in relation to the several embodiments may be further selectively applied to form other possible embodiments of the present invention. Those in the art will further understand that all possible iterations of the present invention are not provided or discussed in detail, even though all combinations and possible embodiments embraced by the several claims below or otherwise are intended to be part of the instant application. In addition, from the above description of several embodiments of the invention, those skilled in the art will perceive improvements, changes, and modifications. Such improvements, changes, and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

What is claimed is:

1. A system for removing moisture from an airstream, the system comprising:
a magnetic mist eliminator comprising:
a separator comprising a first surface, an opposite second surface, and a plurality of holes passing through the first surface and the second surface; wherein the first surface faces an airstream entering an inlet system; and
a magnet that magnetizes the separator, wherein an area of the magnet is connected to the separator in a location adjacent the plurality of the holes; and another area of the magnet is connected to the inlet system;
wherein the magnetic mist eliminator removes mist particles from the airstream, which is flowing through the inlet system.

2. The system of claim 1, wherein components of the inlet system comprise:
a weather hood;
an inlet filter house;
a transition piece;
an inlet duct; and
an inlet plenum.

3. The system of claim 2, wherein the magnetic mist eliminator is positioned near the weather hood.

4. The system of claim 3 further comprising a coalescing media connected to a downstream end of the opposite second surface of the separator.

5. The system of claim 4 further comprising an additional separator connected to a downstream end of the coalescing media.

6. The system of claim 1, wherein a shape of the separator comprises: rectangular, square, circular, triangular, or any combination thereof.

7. The system of claim 6, wherein the shape of the separator is square; and further comprising a plurality of magnets, wherein each corner of the separator is integrated with one of the plurality of magnets.

8. The system of claim 1, wherein the magnet comprises an electromagnet energized by DC current.

9. The system of claim 1, wherein the magnet comprises an electromagnet energized by AC current.

10. The system of claim 1, wherein the magnet comprises a permanent magnet.

11. A system for removing moisture from an airstream, the system comprising:
a turbomachine comprising a compressor and a turbine section;
an inlet system connected to the turbomachine upstream of the compressor; wherein the inlet system comprises: a weather hood; an inlet filter house; a transition piece; an inlet duct; and an inlet plenum;
a magnetic mist eliminator comprising:
a separator comprising a first surface, an opposite second surface, and a plurality of holes passing through the first surface and the second surface; wherein the first surface faces an airstream flowing into an inlet system; and
a magnet that magnetizes the separator, wherein a first side of the magnet is connected to the separator in a location adjacent the plurality of the holes; and a second side of the magnet is connected to the inlet system;
wherein the separator separates mist particles from the airstream, as the airstream flows through the inlet system.

12. The system of claim 11, wherein the separator is connected to the inlet system near the weather hood.

13. The system of claim 12 further comprising a coalescing media connected to the opposite second surface of the separator.

14. The system of claim 13 further comprising an additional separator connected to a downstream end of the coalescing media, wherein the coalescing media is located between the separator and the additional separator.

15. The system of claim 11, wherein a form of the separator comprises: a rectangular shape, a square shape, a circular shape, a triangular shape, or any combination thereof.

16. The system of claim 15 further comprising a plurality of magnets, wherein at least one of the magnets is connected to a surface of the separator.

17. The system of claim 11, wherein the magnet comprises an electromagnet energized by DC current or by AC current.

18. The system of claim 11, wherein the magnet comprises a permanent magnet.

19. The system of claim 11, wherein the magnet operatively induces a force on the separator that repels and separates the mist particles within the airstream.

20. The system of claim 11, wherein the magnet operatively induces a force on the separator that attracts the mist particles within the airstream that is flowing through the magnetic mist eliminator; allowing the mist particles to separate from the airstream and condense near the separator.
